(19) United States
(12) Patent Application Publication
(10) Pub. No.: US 2024/0099302 A1
(43) Pub. Date: Mar. 28, 2024

(54) Use of a Biobased Composition Comprising Ferulated Chitosan for Regulating and Stimulating Plant Growth

(71) Applicant: FYTEKO SA, Bruxelles (BE)

(72) Inventors: Guillaume WÉGRIA, Bruxelles (BE); Juan-Carlos CABRERA PINO, Bruxelles (BE)

(21) Appl. No.: 18/268,211

(22) PCT Filed: Dec. 22, 2021
(86) PCT No.: PCT/EP2021/087264

§ 371 Date: Jun. 16, 2023

(30) Foreign Application Priority Data
Dec. 22, 2020 (BE) BE2020/5966

(51) Int. Cl. A01N 43/16; A01N 25/04; A01P 21/00

(52) U.S. Cl. CPC A01N 43/16; A01N 25/04; A01P 21/00

(57) ABSTRACT

The current invention relates to use of a composition for the regulation and/or stimulation of plant growth in a targeted plant, said composition comprising ferulated chitosan, wherein said composition is applied to said targeted plant and/or to soil in contact with said targeted plant.

### FIELD OF THE INVENTION

The present invention relates to a composition comprising ferulated chitosan. In particular, the present invention concerns the use of such composition for regulating and/or stimulating plant growth.

### BACKGROUND

Over the years, the agricultural industry has gained more and more interest in chemical compounds which are able to modify plant growth. Such compounds go by the general name of plant growth regulators (PGR) and have been successfully used for controlling plant growth and for mastering harvest yield.

PGRs which are used to date are relatively old products, such as ethephon, chlormequat chloride, mepiquat chloride, and gibberellins. As these old products are still performant, very few companies are engaged in searching and developing new PGRs. However, most of these products only have a very basic functionality, and are for example being used to retard shoot growth. Unfortunately, they do not adequately or sufficiently address the many other needs of the agricultural sector: inducing or retarding blooming and/or flowering, inducing crops towards a more vegetative and/or more generative growth phase etc.

Such chemical plant growth regulators are known from EP 0 010 770. While the compounds as disclosed in EP '770 generally function as PGRs, the effect on the above-mentioned specific needs, are not elaborately discussed. Furthermore, as public opinion on chemical products is especially sensitive in the area of agriculture, using chemical compounds such the compounds of EP '770 is not desired. In particular, the use of chemical compounds for agricultural purposes is often associated with a certain risk of toxicity, or a substantial ecological burden on the environment.

Hence, there remains a need in the art for novel PGRs which are non-chemical, bio-based, safe and/or non-toxic, have a high bio-availability to plants, and additionally, which successfully stimulate specific traits in crops, e.g. blooming and/or flowering, inducing a vegetative and/or generative growth phase, and have a large bio-availability in the targeted plant.

### SUMMARY OF THE INVENTION

The present invention and embodiments thereof serve to provide a solution to one or more of above-mentioned disadvantages. To this end, the present invention relates to use of a composition comprising a ferulated chitosan for the regulation and/or stimulation of plant growth in a targeted plant according to claim 1.

It was surprisingly found that ferulated chitosan can be successfully used as a plant growth regulator and/or stimulator. The composition as described herein is particularly advantageous for use as a plant growth regulator and/or stimulator because the composition is bio-based, safe to use, has high bio-availability, and furthermore allows for inducing specific traits in plants.

Preferred embodiments of the present use are disclosed in claims 2 to 15.

### DESCRIPTION OF FIGURES

FIG. 1 shows UV spectra comparing unmodified chitosan and the ferulated chitosan following an embodiment of the present invention.

FIG. 2 shows FTIR spectra comparing unmodified chitosan and the ferulated chitosan following an embodiment of the present invention.

FIG. 3 shows the effect of foliage application of a composition comprising ferulated chitosan following an embodiment of the present invention on the inflorescence in geranium plants.

FIG. 4 shows a Volcano plot demonstrating the effect of foliage application of a composition comprising ferulated chitosan following an embodiment of the present invention on gene expression in model tomato plants.

FIG. 5 shows the characterization by size exclusion chromatography of ferulated chitosan according to an embodiment of the present invention.

### DETAILED DESCRIPTION OF THE INVENTION

The present invention concerns the use of a composition comprising a ferulated chitosan for the regulation and/or stimulation of plant growth in a targeted plant.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

As used herein, the following terms have the following meanings:

“A”, “an”, and “the” as used herein refers to both singular and plural referents unless the context clearly dictates otherwise. By way of example, “a compartment” refers to one or more than one compartment.

“Comprise”, “comprising”, and “comprises” and “comprised of” as used herein are synonymous with “include”, “including”, “includes” or “contain”, “containing”, “contains” and are inclusive or open-ended terms that specifies the presence of what follows e.g. component and do not exclude or preclude the presence of additional, non-recited components, features, element, members, steps, known in the art or disclosed therein.

The recitation of numerical ranges by endpoints includes all numbers and fractions subsumed within that range, as well as the recited endpoints.

The expression “% by weight”, “weight percent”, “% wt.” or “wt. %”, here and throughout the description unless otherwise defined, refers to the relative weight of the respective component based on the overall weight of the formulation.

Unless otherwise defined, all terms used in disclosing the invention, including technical and scientific terms, have the meaning as commonly understood by one of ordinary skill in the art to which this invention belongs. By means of further guidance, definitions for the terms used in the description are included to better appreciate the teaching of the present invention. The terms or definitions used herein are provided solely to aid in the understanding of the invention.

A first aspect of the present invention relates to use of a composition for the regulation and/or stimulation of plant growth in a targeted plant, said composition comprising a ferulated chitosan, wherein said composition is applied to said targeted plant and/or to soil in contact with said targeted plant. The inventors have surprisingly found that ferulated chitosan can be successfully used as a plant growth regulator and/or stimulator. The composition as described herein is particularly advantageous for use as a plant growth regulator and/or stimulator because the composition is bio-based: it is not a hormone, nor a chemical compound, and it is safe for both human health and for the environment.

The term “ferulated chitosan”, indicates a compound having a chitosan backbone, whereupon ferulic acid is grafted on the chitosan's amine group. In the context of the present invention, “chitosan” need to be interpreted as a linear polysaccharide composed of randomly distributed beta-(1-4) linked D-glucosamine and N-acetyl-D-glucosamine moieties. The term “ferulic acid”, also known as ((2E)-3-(4-hydroxy-3methoxyphenyl) prop-2-enoic acid, is thus grafted on the chitosan, preferably on the chitosan's amine group, and can possibly be grafted as a monomer, dimer and/or trimer, and/or in different isomer forms.

It is a key advantage of the herein described use of the composition comprising ferulated chitosan, that use of the composition results in a noticeable shift in a plant from a vegetative growth phase to a generative growth phase. As such, plant growth can be effectively regulated. Exemplary is the production of fruits and vegetables, wherein a long vegetative growth stage is not of particular interest. In such cases, the plant is preferably kept in a vegetative growth phase only early on, and is soon pushed towards a more generative growth stage, i.e. pushed towards fruit and vegetable production.

By preference, the use of the composition as herein described for regulation and/or stimulation of plant growth comprises increasing harvest yield of said targeted plant. It is clear that this is a particular advantage for the agricultural industry, which aim to optimize crop yield in function of the used resources. Harvest yield optimization has to date only successfully been achieved by the use of chemical compounds which have proven to be unsafe towards human health, and/or which form a substantial burden on the environment. Herein, use of the present composition is safe to use, while efficiently optimizing harvest yield in a targeted plant.

According to a further or another embodiment, said regulation and/or stimulation of plant growth comprises increasing flowering of said targeted plant. Although stimulation of crop yield is a particular advantage, some crops are specifically grown for their flowers. It has been found that use of the composition as herein described results in the increase of flowering, which is a particular interest of the floricultural industry. As such, use of the composition will result in a larger amount of flowers per plant and/or will successfully induce plant growth towards a higher ratio between flowers and other plant parts, such as foliage, stems, roots etc.

In some embodiments, said regulation and/or stimulation of plant growth comprises shortening the time to harvest of fruits. Use of the composition steers energy use in the plant towards generative growth, thereby increasing the efficiency of fruit growth, thus resulting in a shorter time to harvest.

According to a further or another embodiment, regulation and/or stimulation of plant growth comprises increasing the amount of fruit produced by the targeted plant. Although general stimulation of crop yield is a particular advantage, some crops are specifically grown for harvesting fruits, e.g. tomato plants. Use of the present composition now achieves a larger amount of fruit produced per plant, and thus allows to harvest a larger amount of fruit on a same soil area, or alternatively to harvest a same amount of fruit on a smaller soil area.

A further or another embodiment of the present invention relates to use of the composition wherein said ferulated chitosan has a concentration of between 1 to 100.000 ppm based on the total weight of said composition. Within said concentration range, the composition shows optimal effects towards the increase of harvest yield, the increase of flowering and/or blooming and to the increase of fruit production, at the same time having optimal effects towards a broad range of targeted plants. Use of the composition does not lead to a risk of toxicity in the environment within the concentration range as described herein. By preference, the ferulated chitosan has a concentration of between 1 to 5.000 ppm, more by preference of between 1 to 4.000 ppm, of between 1 to 3.000 ppm, 1 to 2.000 ppm, 1 to 1.500 ppm, or of between 1 to 1.000 ppm based on the total weight of the composition. In some embodiments, the composition can be in a more concentrated form, which is preferred for transport and storing the composition, wherein the ferulated chitosan has a concentration of between 500 to 1.000 ppm, by preference of between 600 to 900 ppm, more by preference of between 700 to 800 ppm. In some embodiments, the composition is in a more diluted form, which is preferred for direct application to plants, wherein the ferulated chitosan has a concentration of between 1 to 50 ppm, by preference of between 1 to 25 ppm, more by preference of between 1 to 10 ppm.

In an embodiment, ferulated chitosan is produced according to a method comprising the steps of:
dispersing chitosan in a solution with a pH between 5.0 and 9.0 and adding ferulic acid and an enzyme of the family of multi-copper oxidases, obtaining a mixture;
allowing the mixture to enzymatically react;
recovering a precipitate from the reacted mixture.

In an embodiment, ferulated chitosan is produced according to a method comprising the steps of:
dispersing powdered chitosan in a solution with a pH between 5.0 and 9.0, preferably with a pH between 6.0 and 8.0, more preferably a phosphate buffer solution with a pH of 6.8-7.2;
adding ferulic acid to the solution with chitosan, preferably a solution of 2-10 mM of ferulic acid, more preferably a solution of 4.5-5.5 mM of ferulic acid in methanol;
adding an enzyme of the family of multi-copper oxidases (MCOs) to the solution with chitosan and ferulic acid, preferably the enzyme is laccase, more preferably a laccase solution of 0.5-2.0 U/mL is added;
allowing the solution to enzymatically react, preferably at a temperature of 15-40° C. and under agitation, during 1-24 hours, more preferably at 25-35° C. and under agitation at 100-140 rpm, during 3-5 hours;
recovering a precipitate, preferably by centrifugation;
washing the recovered precipitate with a buffer, preferably with a phosphate buffer;
washing with an alcohol the washed precipitate, preferably two washing steps with two different methanol solutions, more preferably the two methanol solutions have a concentration of 45-55% and 85-95%, respectively.

Without wanting to be bound by theory, the enzymatic reaction between chitosan and ferulic acid may lead to many different products. In some embodiments, ferulated chitosan comprises several different molecules comprising at least one ferulic acid moiety grafted on a D-glucosamine moiety of chitosan.

In order to remove laccase and to purify the ferulated chitosan, a washing step with a buffer is conducted. The washing with an alcohol removes the unreacted ferulic acid. This way a purer ferulated chitosan is obtained.

Said ferulated chitosan according to some embodiments comprises an oligomeric and/or polymeric compound following formula (I)

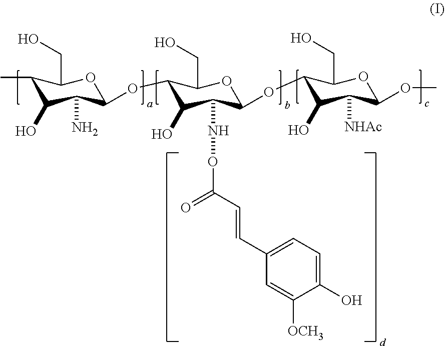

which compound comprises a D-glucosamine moiety (a), a ferulated D-glucosamine moiety (b), and an acetylated D-glucosamine moiety (c), wherein said moieties are randomly distributed in said compound following a ratio a:b:c, wherein:

a+b+c>15;

b/(a+b+c)<0.10; and

c/(a+b+c)<0.30;

and wherein d=1, 2 or 3.

The ferulated chitosan described herein shows excellent bio-availability in plants, wherein it can optimally induce regulation and/or stimulation of growth. More by preference, said moieties are randomly distributed following the ratio a:b:c, wherein:

a+b+c>20;

b/(a+b+c)<0.10; and

c/(a+b+c)<0.10;

and wherein d=1, 2 or 3.

Even more by preference, a+b+c>100, a+b+c>250, a+b+c>500, most by preference 600<a+b+c<1000.

Without wanting to be bound by theory, ferulated chitosan can comprise said randomly distributed moieties in many different formations, not only as shown in formula I. In an embodiment, ferulated chitosan comprises ferulic acid covalently bound with chitosan via its benzene moiety. In an embodiment, ferulated chitosan comprises ferulic acid covalently bound with chitosan via its carboxyl moiety. In an embodiment, ferulated chitosan comprises ferulic acid covalently bound with chitosan via its hydroxyl moiety. In an embodiment, ferulated chitosan comprises chitosan covalently bound with ferulic acid via its hydroxyl group on the third carbon atom of a D-glucosamine moiety. In an embodiment, ferulated chitosan comprises chitosan covalently bound with ferulic acid via its hydroxyl group on the sixth carbon atom of a D-glucosamine moiety. In an embodiment, ferulated chitosan comprises ferulic acid covalently bound with chitosan via an imine bound. In an embodiment, ferulated chitosan comprises ferulic acid ionically bond to chitosan.

In an embodiment, ferulated chitosan comprises a D-glucosamine moiety (a), a ferulated D-glucosamine moiety (b), and an acetylated D-glucosamine moiety (c), wherein said moieties are randomly distributed in said compound following a ratio a:b:c, wherein:

a+b+c>15;

b/(a+b+c)<0.10; and

c/(a+b+c)<0.30;

and wherein d=1, 2 or 3.

More by preference, said moieties are randomly distributed following the ratio a:b:c, wherein:

a+b+c>20;

b/(a+b+c)<0.10; and

c/(a+b+c)<0.10;

and wherein d=1, 2 or 3.

Even more by preference, a+b+c>100, a+b+c>250, a+b+c>500, most by preference 600<a+b+c<1000.

Without wanting to be bound by theory, the bond between the chitosan and ferulic acid could be ionic according to Formula II:

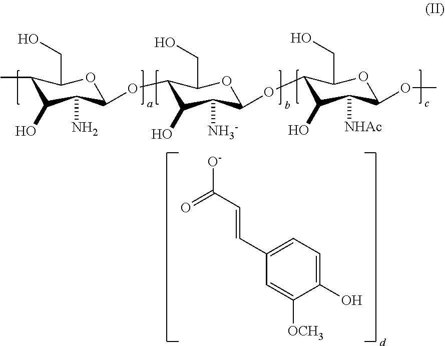

which compound comprises a D-glucosamine moiety (a), a ferulated D-glucosamine moiety (b), and an acetylated D-glucosamine moiety (c), wherein said moieties are randomly distributed in said compound following a ratio a:b:c, wherein:

a+b+c>15;

b/(a+b+c)<0.10; and

c/(a+b+c)<0.30;

and wherein d=1, 2 or 3.

Without wanting to be bound by theory, the bond between the chitosan and ferulic acid could be ionic according to Formula III:

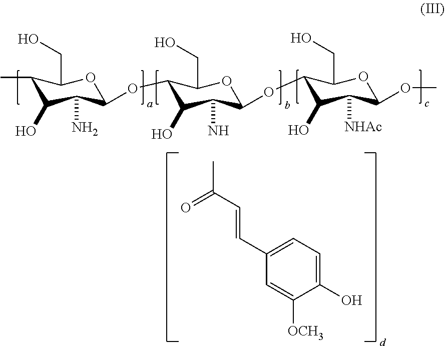

which compound comprises a D-glucosamine moiety (a), a ferulated D-glucosamine moiety (b), and an acetylated D-glucosamine moiety (c), wherein said moieties are randomly distributed in said compound following a ratio a:b:c, wherein:

a+b+c>15;

b/(a+b+c)<0.10; and

c/(a+b+c)<0.30;

and wherein d=1, 2 or 3.

The ferulated chitosan described herein shows excellent bio-availability in plants, wherein it can optimally induce regulation and/or stimulation of growth. More by preference, said moieties are randomly distributed following the ratio a:b:c, wherein:

a+b+c>20;

b/(a+b+c)<0.10; and

c/(a+b+c)<0.10;

and wherein d=1, 2 or 3.

Even more by preference, a+b+c>100, a+b+c>250, a+b+c>500, most by preference 600<a+b+c<1000.

In a further or another embodiment, the composition comprises a water-insoluble solvent and water, wherein said composition is an oil-in-water emulsion having an oil to water ratio of between 1:20 to 20:20.

As described herein, an “emulsion” relates to a mixture of two or more liquids that are normally immiscible due to liquid-liquid separation. Emulsions are thus part of a more general class of two-phase systems called “colloids”. Practically, in an emulsion one liquid (the dispersed phase) is dispersed in the other (the continuous phase). Emulsions generally comprise two main classes, and are either oil-in-water or water-in-oil. The emulsions of the present invention concern oil-in-water emulsions, thus emulsions in which the continuous phase is water and the dispersed phase is oil-based.

The present invention now succeeds at further improving bio-availability of the ferulated chitosan composition as described herein, therefore serves as an excellent plant growth regulating and/or stimulating compound. In particular, as ferulated chitosan has a low solubility in water, the invention provides for a stable emulsion in which the ferulated chitosan does not precipitate, even during long-term storage. Whereas emulsions are generally sensitive to shear forces during manufacture or during dilution and/or mixing of the formulation with water, the present formulation furthermore has excellent stability during dilution and/or mixing in water within the oil to water ratio as herein described.

According to a further or another embodiment, said water-insoluble solvent has a concentration of between 5.00 and 50.00 wt. % based on the total weight of said composition. The water-insoluble solvent is thus a major contributor in the oil phase of the emulsion. As such, it serves as a carrier for the ferulated chitosan, and aids in stabilization of the emulsion, homogeneous distribution of the ferulated chitosan in the composition, as well as improving bio-availability of the ferulated chitosan to plants, thereby allowing optimal effect towards plant regulation and/or stimulation. By preference, the water-insoluble solvent has a concentration of between 5.00 and 40.00 wt. %, more by preference of between 5.00 and 30.00 wt. %, between 5.00 and 20.00 wt. %, even more by preference of between 5.00 and 10.00 wt. % based on the total weight of the composition.

In some embodiments, the composition comprises a rheological modifier, wherein said rheological modifier has a concentration of between 0.10 and 30.00 wt. % based on the total weight of said composition. The rheological modifier aims to increase the viscosity of the composition, thereby further increasing long-term emulsion stability, while avoiding creaming of the emulsion components and reducing coalescence. It is submitted that also bio-availability of the ferulated chitosan was further improved by influence of the rheological modifier, thereby allowing optimal plant growth regulation and/or stimulation. By preference, the rheological modifier has a concentration of between 0.10 and 20.0 wt.%, more by preference of between 0.10 and 5.00 wt. %, even more by preference of between 0.10 and 1.0 wt. %.

According to a further or another embodiment, the composition comprises a hydrophilic and/or a lipophilic surfactant, wherein said hydrophilic and/or lipophilic surfactant have a concentration of between 0.01 and 10.00 wt. % based on the total weight of said composition. The term “surfactant” herein relates to organic compounds that are amphiphilic, indicating that they contain both hydrophobic groups and hydrophilic groups. Therefore, a surfactant contains both a water-insoluble (or oil-soluble) component and a water-soluble component. As a result of their specific structure, surfactants will diffuse in water and adsorb at interfaces between an oil and a water phase.

The hydrophile-lipophile balance (HLB) number is used as a measure of the ratio of hydrophilic and lipophilic groups in a surfactant. It is generally a value between 0 and 60 defining the affinity of a surfactant for water or oil. HLB numbers are calculated for nonionic surfactants, and these surfactants have numbers ranging from 0-20. HLB numbers >10 have an affinity for water (hydrophilic) and number <10 have an affinity of oil (lipophilic). Ionic surfactants have recently been assigned relative HLB values, allowing the range of numbers to extend to 60.

The surfactants as described herein facilitate a better surface coverage (e.g. plant leaves wetting), improved spreading and maintaining hydration during the application on plants, e.g. by spraying on plant leaves. The surfactants thus allow to further stabilize the emulsion of the present composition, which can be effectively used to regulate and/or stimulate plant growth, and which as an exceptionally high bio-availability in plants. By preference, said hydrophilic and/or lipophilic surfactant have a concentration of between 0.01 and 9.00 wt. %, of between 0.01 and 8.00 wt. %, of between 0.01 and 7.00 wt. %, of between 0.01 and 6.00 wt. %, or of between 0.01 and 5.00 wt. % based on the total weight of said composition. Even more by preference, said hydrophilic and/or lipophilic surfactant have a concentration of between 0.05 and 5.00 wt. %, of between 0.10 and 5.00 wt. %, of between 0.15 and 5.00 wt. %, of between 0.20 and 5.00 wt. %, or of between 0.25 and 5.00 wt. % based on the total weight of said composition.

According to a further or another embodiment, the composition comprises a hydrophilic and a lipophilic surfactant, wherein each of said hydrophilic and said lipophilic surfactant has a concentration of between 0.01 and 10.00 wt. % based on the total weight of said composition. By preference, each of said hydrophilic and lipophilic surfactant has a concentration of between 0.01 and 9.00 wt. %, of between 0.01 and 8.00 wt. %, of between 0.01 and 7.00 wt. %, of between 0.01 and 6.00 wt. %, or of between 0.01 and 5.00 wt. % based on the total weight of said composition. Even more by preference, each of said hydrophilic and lipophilic surfactant has a concentration of between 0.05 and 5.00 wt. %, of between 0.10 and 5.00 wt. %, of between 0.15 and 5.00 wt. %, of between 0.20 and 5.00 wt. %, or of between 0.25 and 5.00 wt. % based on the total weight of said composition.

The water-insoluble solvent according to some embodiments, is a vegetable oil or vegetable oil ester, chosen from the group of linseed oil, rapeseed oil, soybean oil, palm oil, coconut oil, canola oil, sunflower oil, their esters, or combinations thereof.

Said rheological modifier according to some embodiments, is chosen from the group of guar gum, xanthan gum, gellan gum, alginates, cellulose derivatives like hydroxyethylcellulose, methylcellulose, hydroxypropylcellulose, acrylates, poly-esters, polyester block co-polymers, polyamides, polyquaternium emulsions, polyvinyl alcohol, waxes, clays, pyrogenic silica, or combinations thereof.

The rheological modifier as described herein provides the composition with shear thinning and/or thixotropic properties, which allows the composition to be even more efficiently applied to plants. By preference, said rheological modifier is chosen from the group of guar gum, xanthan gum, gellan gum, alginates, or combinations thereof.

According to a further or another embodiment, said hydrophilic surfactant is chosen from the group of Tween 20, Tween 21, Tween 40, Tween 60, Tween 65, Tween 80, Tween 81, Tween 85, PEG 400 monooleate, PEG 400 monostearate, PEGE 400 monolaurate, potassium oleate, sodium lauryl sulfate, triethanolamine oleate, polyalkylene oxide block co-polymers, or combinations thereof.

According to a further or another embodiment, said lipophilic surfactant is chosen from the group of Span 20, Span 40, span 60, Span 65, Span 80, Span 85, Tween 61, glycerol monostearate, acrylic co-polymers, co-polymers of polyethylene glycol, 12-hydroxystearic acid, or combinations thereof.

According to a further or another embodiment, the composition has a pH of between 4.0 and 7.0. By preference, the composition has a pH of between 5.0 and 6.5.

According to some embodiments, said applying the composition to the targeted plant comprises foliar application through spraying of the composition on leaves of the targeted plant. Spraying of the composition is a particularly favorable method of application as it allows homogeneous distribution of the composition over the targeted plants. Furthermore, spraying is a very fast method of distributing the composition, allowing the treatment of a large surface area of plants. Bio-availability of the ferulated chitosan through foliar spraying to targeted plants is exceptionally large.

According to a further or another embodiment, said applying the composition to the targeted plant comprises soil application through spraying and/or drenching of the composition on the soil in contact with said targeted plant. This application method alternatively or additionally allows for the easy application of the composition on a large amount of plants, meanwhile ensuring a homogeneous distribution and optimal bio-availability of the ferulated chitosan towards the targeted plants.

In a second aspect, the invention relates to a method for the production of ferulated chitosan comprising the steps of:
dispersing chitosan in a solution with a pH between 5.0 and 9.0 and adding ferulic acid and an enzyme of the family of multi-copper oxidases, obtaining a mixture;
allowing the mixture to enzymatically react;
recovering a precipitate from the reacted mixture.

In an embodiment, the method for the production of ferulated acid comprises the steps of:
dispersing powdered chitosan in a solution with a pH between 5.0 and 9.0, preferably with a pH between 6.0 and 8.0, more preferably a phosphate buffer solution with a pH of 6.8-7.2;
adding ferulic acid to the solution with chitosan, preferably a solution of 2-10 mM of ferulic acid, more preferably a solution of 4.5-5.5 mM of ferulic acid in methanol;
adding an enzyme of the family of multi-copper oxidases (MCOs) to the solution with chitosan and ferulic acid, preferably the enzyme is laccase, more preferably a laccase solution of 0.5-2.0 U/mL is added;
allowing the solution to enzymatically react, preferably at a temperature of 15-40° C. and under agitation, during 1-24 hours, more preferably at 25-35° C. and under agitation at 100-140 rpm, during 3-5 hours;
recovering a precipitate, preferably by centrifugation;
optionally washing the recovered precipitate with a buffer, preferably with a phosphate buffer;
optionally washing with an alcohol the washed precipitate, preferably two washing steps with two different methanol solutions, more preferably the two methanol solutions have a concentration of 45-55% and 85-95%, respectively.

Enzymatic production of ferulated chitosan is desired over chemical synthesis. Enzymes improve the selectivity and reaction speed of the reaction and are easy to use. Fewer impurities are obtained. The obtained precipitate contains high concentrations of ferulated chitosan. In an embodiment, the obtained ferulated chitosan is used according to the first aspect.

In another aspect, the invention relates to ferulated chitosan obtainable according to the second aspect and used according to the first aspect.

### EXAMPLES

The invention is further described by the following non-limiting examples which further illustrate the invention, and are not intended to, nor should they be interpreted to, limit the scope of the invention.

### Example 1

### Compositions Comprising Ferulated Chitosan

The tables below contain example compositions comprising a ferulated chitosan according to the present invention. The compositions provided therein are particularly suited for use in the growth regulation and/or stimulation of plants.

TABLE 1
Ferulic acid grafted chitosan composition A

| Component | Function | Concentration |
|---|---|---|
| Ferulated chitosan | Active ingredient | 0.10 wt. % |
| Soybean oil | Water-insoluble solvent | 8.00 wt. % |
| Tween 20 | Hydrophilic surfactant | 1.00 wt. % |
| Xanthan gum | Rheological modifier | 1.00 wt. % |
| Water | Solvent | 89.90 wt. % |

TABLE 2
Ferulated chitosan composition B

| Component | Function | Concentration |
|---|---|---|
| Ferulated chitosan | Active ingredient | 1.00 wt. % |
| Rapeseed oil | Water-insoluble solvent | 14.00 wt. % |
| Tween 80 | Hydrophilic surfactant | 2.00 wt. % |
| Gellan gum | Rheological modifier | 2.00 wt. % |
| Water | Solvent | 81.00 wt. % |

TABLE 3
Ferulated chitosan composition C

| Component | Function | Concentration |
|---|---|---|
| Ferulated chitosan | Active ingredient | 5.00 wt. % |
| Linseed oil | Water-insoluble solvent | 10.00 wt. % |
| Span 20 | Lipophilic surfactant | 1.00 wt. % |
| Methylcellulose | Rheological modifier | 1.00 wt. % |
| Water | Solvent | 83.00 wt. % |

TABLE 4
Ferulated chitosan composition D

| Component | Function | Concentration |
|---|---|---|
| Ferulated chitosan | Active ingredient | 6.00 wt. % |
| Sunflower oil | Water-insoluble solvent | 20.00 wt. % |
| PEG 400 monostearate | Hydrophilic surfactant | 0.75 wt. % |
| Glyceryl monostearate | Lipophilic surfactant | 0.75 wt. % |
| Guar gum | Rheological modifier | 3.00 wt. % |
| Water | Solvent | 69.50 wt. % |

### Example 2

### Preparation and Characterization of Ferulated Chitosan

The present example merely serves to show a possible method of producing a ferulated chitosan, and should not be considered limiting for the present invention. In this example, ferulated chitosan was produced by enzymatic grafting, in particular by laccase enzymatic grafting.

Ferulated chitosan is produced following the steps:
1. Dispersing powdered chitosan in a phosphate buffer of pH 7.0;
2. Adding a solution of 5 mM of ferulic acid (in methanol);
3. Adding a solution of 1 U/mL of laccase;
4. Allowing the mixture to enzymatically react at a temperature of 30° C. and under agitation at 120 rpm, during 4 hours;
5. Recovering the resulting ferulated chitosan by centrifugation;
6. Purifying the ferulated chitosan by washing with phosphate buffer in order to remove laccase, and subsequent washing with 50% and 90% methanol solutions to remove unreacted ferulic acid.

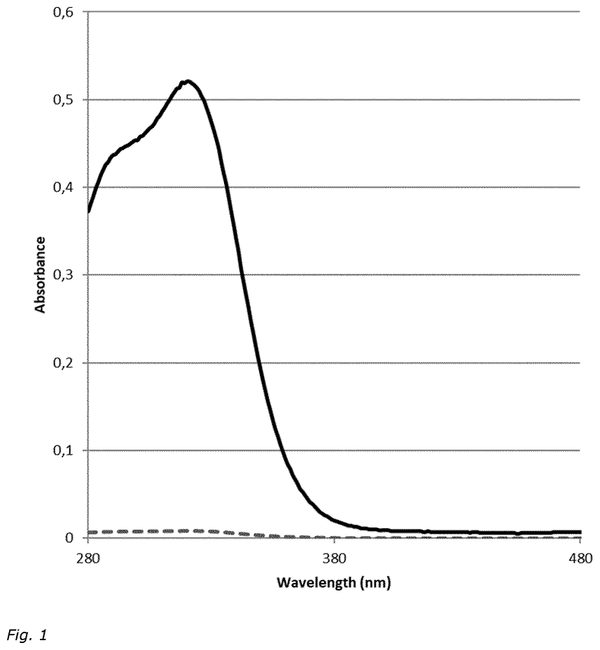

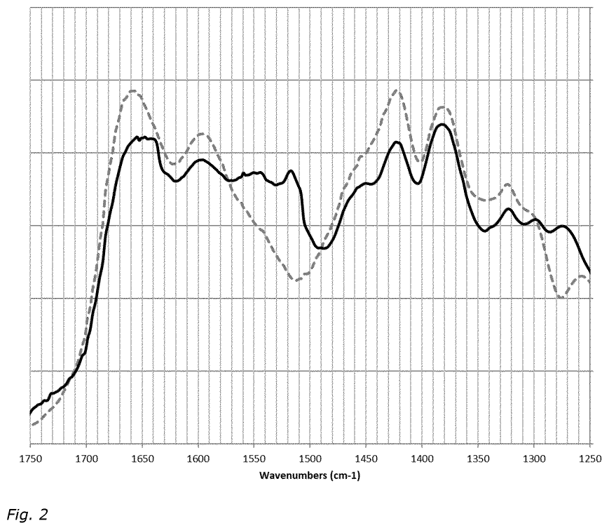

In order to characterize the final product, both unmodified chitosan and ferulated chitosan samples were dissolved at 0.05% (w/v) in aqueous acetic acid (1%) at pH 4.5 and the UV spectrum was recorded using spectrophotometer scanning at 280-480 nm. Additionally, an FT-IR analysis were carried out by the potassium bromide (KBr) pellet method with a Perkin-Elmer Spectrum One FT-IR spectrometer (Norwalk, USA) in the range of 400-4000 cm-1 with 120 scans. Results are shown in FIGS. 1 and 2. FIG. 1 herein shows the UV spectra comparing the unmodified chitosan (dotted line) and the ferulated chitosan (full line) following the present invention. A large band of absorbance around 320 nm is observed, demonstrating that ferulic acid successfully reacted with the chitosan. Furthermore, FIG. 2 shows the FTIR spectra comparing the unmodified chitosan (dotted line) and the ferulated chitosan (full line) following the present invention. a shift of the maximum of the band at 1660 cm-1 to 1645 cm-1 characteristic of Schiff base formation was observed and new bands appear at 1540 cm-1 and 1520 cm-1, demonstrating the successful reaction of ferulic acid with the chitosan.

### Example 3

### Preparation of a Foliar Spraying Formulation Comprising Ferulated Chitosan

As the absorption of an active ingredient by the plant surface involves a series of complex processes and events, active ingredients are formulated in order to be effectively applied on the field and delivered to the target plant for maximum efficacy.

The formulation as exemplified herein furthermore shows excellent stability and shelf-life stability.

A stable and homogeneous formulation containing 0.01 wt. % of ferulated chitosan is prepared as follows:
1. Providing the aqueous phase, by mixing:
   1 part of 1% solution of ferulated chitosan in a phosphate buffer at pH 5,7;
   93 parts 0.5% Xanthan gum solution; and
   1 part of Tween 20;
2. Providing the oil phase: soybean refined oil;
3. Preparing an oil-in-water emulsion by gradually adding the oil phase to the aqueous phase, meanwhile homogenizing the mixture thereof by means of a homogenizer (Ultra Turrax, model T25, IKA Works, USA) at 24,000 rpm for 5 min.

Stability of the resulting composition is characterized following CIPAC method 46.1.3 in the following table.

TABLE 5
Characterization of the composition comprising ferulated chitosan

| | Stability | pH |
|---|---|---|
| Initial | Stable | 5.5 |
| 14 days at 4° C. | Stable | 5.5 |
| 14 days at 54° C. | Stable | 5.5 |

It is further exemplified in the table below that the composition has a favorable surface tension during further dilution in water, and remains stable herein. Determination of surface tension is based on the Wilhelmy plate method.

TABLE 6
Surface tension of the composition comprising ferulated chitosan.

| Dilution factor | Surface tension (mN · m⁻¹) | Standard deviation |
|---|---|---|
| Water | 73.7 | 0.2 |
| 0.001 | 54.4 | 0.1 |
| 0.002 | 54.2 | 0.3 |
| 0.004 | 53.5 | 0.2 |
| 0.006 | 52.2 | 0.2 |
| 0.008 | 50.1 | 0.1 |
| 0.010 | 48.1 | 0.2 |

### Example 4

### Effect on Flowering in Ornamental Plants

Pelargonium x hortorum, (also known as zonal geranium or garden geranium), is a hybrid of Pelargonium most commonly used as an ornamental plant, mainly kept as a potted plant in apartments and in various types of containers on balconies, window sills and, verandas. The advantages of this plant are the long-blooming flowers and decorative leaves.

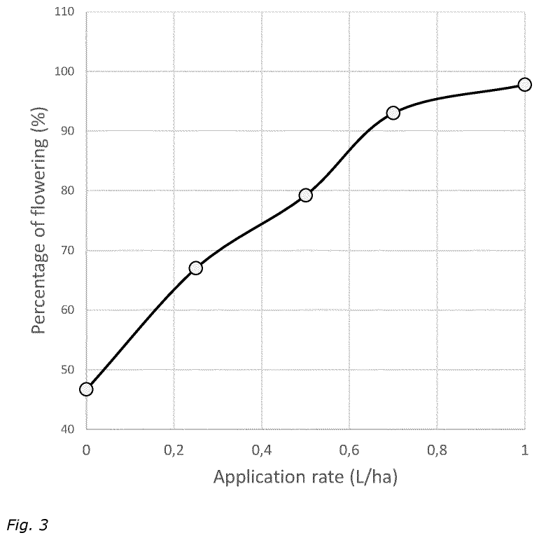

A composition comprising ferulated chitosan according to Example 1 was applied by foliar spraying on young geranium plants. After a short simulation of water stress, the flowering of geranium plants was evaluated. The effect foliage application of a ferulated chitosan comprising composition on the inflorescence in geranium plants is shown in FIG. 3. The results of this experiment clearly show that treated plants show a larger percentage of flowering, which increases with application rate of the composition. A larger foliar area was observed with all treated plants in comparison to untreated plants. Furthermore, treated plants produced better quality flowers, both in terms of color and size.

### Example 5

### Effect on Harvest Yield of Tomato Plants

The effect of foliar spraying of a formulation comprising ferulated chitosan following Example 1 on tomato plants (Lycopersicon esculentum Mill) was evaluated as follows:
1. 25 tomato plants were grown as a control, whereas 25 tomato plants were grown to be treated with the composition according to the present invention;
2. Treated plants were sprayed with a diluted solution (4/250) of the formulation containing ferulated chitosan using an atomizer at week 6 after transplanting; p1 3. Diverse growth parameters and yield were evaluated one month after treatment, comparing the control plants and the treated plants.

TABLE 7
Effect of foliar spraying of ferulated chitosan composition
on tomato plant growth parameters and yield

| | Control | Treated |
|---|---|---|
| Growth parameters | | |
| Plant height (cm) | 85.4 | 73.0 |
| Branches per plant | 39.0 | 46.0 |
| Leaves per plants | 304 | 277 |
| Area per leaf (cm²) | 39.1 | 24.0 |
| Yield | | |
| Fruits per plant | 6.4 | 9.6 |
| Fruit yield per plant (g) | 210.2 | 339.2 |

The results shown herein demonstrate that foliar spraying of a ferulated chitosan composition according to the present invention on tomato plants produced more compact plants, with lower foliar area and producing higher number of fruits per plants.

### Example 6

### Effect of Foliar Application in Tomato Plants

Transcriptome analysis is a powerful tool that can identify differential gene expression in tissues or development stages, or in response to an external stimulus. The influence of foliar spraying of a composition according to the present invention on plant mRNA transcriptomes was investigated using the model plant Solanum lycopersicum (tomato plant).

In this study, tomato plants were growth for 2 weeks on soil under controlled conditions (light/dark regime of 16 h/8 h respectively, at 28° C.). After two weeks, half of the plants were sprayed with a solution containing ferulated chitosan, while the other half was used as control (C). All plant leaves from three biological replicates were snap-frozen in liquid nitrogen. Sample collection was conducted two days after foliar spraying treatment. RNA Extraction and Purification from tomato leaves, cDNA synthesis, fluorescent labeling, and Microarray Hybridization, Scanning and Image Analysis were carried out.

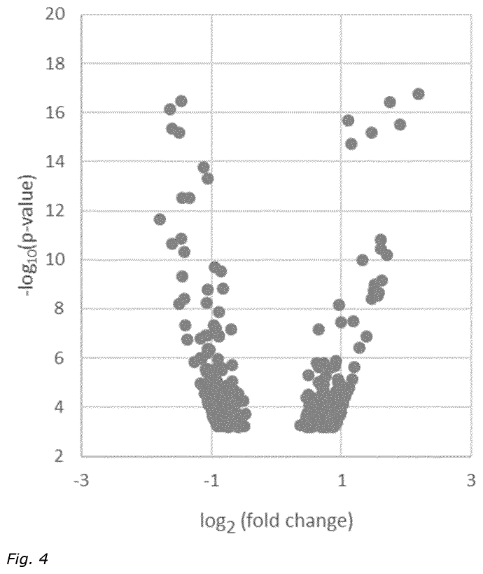

Foliar application with a composition following the present invention demonstrated a significant effect on the plant transcriptome, by dysregulating expression of about 1.0% (336 genes) of the total genes detected by the microarray. Per example, FIG. 4 herein shows a Volcano plot demonstrating changes in gene expression for foliar sprayed treated tomato plants relative to water-treated control. Plotted are the p values on the Y-axes in log 10 scale against the ratio of gene expression on the X-axes in log 2 scale.

An ontology analysis of the differentially expressed genes is shown in the following tables.

TABLE 8
Biological process categorization by Gene Ontology Consortium
Classification of Genes dysregulated by foliar spraying.
Biological process categorization

| | Up- | Down- |
|---|---|---|
| | regulated | regulated |
| | genes | genes |
| cellular component | 6 | 6 |
| organization or biogenesis | | |
| cellular process | 32 | 28 |
| localization | 12 | 3 |
| reproduction | — | — |
| biological regulation | 8 | 9 |
| response to stimulus | 11 | 11 |
| developmental process | 1 | 4 |
| multicellular organismal process | — | 2 |
| metabolic process | 46 | 31 |
| immune system process | — | — |
| not assigned | 54 | 72 |
| Total annotations | 170 | 166 |

TABLE 9
Molecular function categorization by Gene Ontology Consortium
Classification of Genes dysregulated by foliar spraying.
Molecular function categorization

| | Up-regulated | Down- |
|---|---|---|
| | genes | regulated genes |
| translation regulator activity | 1 | |
| binding | 24 | 12 |
| receptor activity | 3 | |
| structural molecule activity | 4 | 2 |
| signal transducer activity | — | |
| catalytic activity | 51 | 34 |
| transporter activity | 14 | 8 |
| antioxidant activity | 1 | 3 |
| not assigned | 72 | 107 |
| Total annotations | 170 | 166 |

The biological process categories containing the highest number of dysregulated genes after application of the composition comprising ferulated chitosan were metabolic and cellular processes, while genes associated with catalytic activities represented the largest group of genes dysregulated by application of the present composition. The results thus demonstrate the effect of the present composition as a plant growth regulator and/or stimulator on a molecular and/or genetic level.

### Example 7

### Effect of Foliar Application in Arabidopsis Plants

Arabidopsis thaliana seeds were sown in soil and the pots were kept for four days for vernalization (4° C. in darkness) for uniform seed germination. Afterward, the pots were kept in a growth chamber in a 12h light (21° C., 60% relative humidity)/12h dark (16° C., 70% relative humidity) cycle. At least 20 developed 30 day-old plants were used for the experiments. Half of the plants were sprayed with a solution comprising ferulated chitosan, the other half was used as control (C). All plant leaves from three biological replicates were snap-frozen in liquid nitrogen. Sample collection was conducted three days after foliar spraying treatment, and transcriptome sequencing was performed.

The table below shows the number of genes which were differentially expressed after treatment with the present composition. Only genes dysregulated with fold times >2 in relation to control were considered.

TABLE 10
Number of genes differentially expressed in Arabidopsis after
foliar spraying with a composition comprising ferulated chitosan

| | Number | Differentially expressed |
|---|---|---|
| | of genes | genes (%) |
| Up-regulated | 3871 | 55.1 |
| Down-regulated | 3156 | 44.9 |
| Total | 7027 | |

These above results demonstrated that foliar application of a composition comprising ferulated chitosan on plants has a high impact on plant transcriptome. To gain insights into the molecular mechanisms involved in bioactivity of ferulated chitosan, a Gene Ontology (GO) enrichment analysis of the differentially expressed genes (DEG) was performed. A selection of them are summarized in the table below.

TABLE 11
Number of differentially regulated genes directly associated
to plant growth and development process.

| | | Number | Percentage of |
|---|---|---|---|
| | | of | of associated |
| | ID | genes | genes (%) |
| vegetative to reproductive | GO:0010228 | 13 | 6.44 |
| phase transition of meristem | | | |
| photoperiodism. flowering | GO:0048573 | 7 | 6.60 |
| seed germination | GO: 0009845 | 8 | 4.88 |
| response to inorganic | GO: 0010035 | 49 | 5.19 |
| substance | | | |
| regulation of shoot system | GO:0048831 | 14 | 6.73 |
| development | | | |
| pigment metabolic process | GO: 0042440 | 13 | 6.91 |

These results demonstrated that among the differentially regulated genes, a significant number of them are associated with biological processes linked to the regulation of plant growth and development. It is thereby shown that treatment of Arabidopsis with a composition comprising ferulated chitosan has a major influence in plant growth regulatory processes.

### Example 8

### Characterization of Ferulated Chitosan by Size Exclusion Chromatography

The present example demonstrates the role of the enzyme in the formation of ferulated chitosan. In this example, a mixture of chitosan and ferulic acid (Chitosan+FA) was prepared as follow: ferulic acid was dissolved by stirring in hot purified water, chitosan was added afterwards. On the other hand, ferulated chitosan was produced by enzymatic grafting as explained in example 2, in particular by laccase enzymatic grafting. The size exclusion chromatographic profiles of both products are compared in the figure.

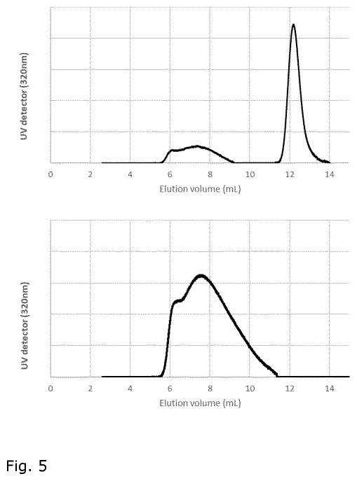

FIG. 5 shows HPSEC chromatograms of a mixture of chitosan and ferulic acid (Chitosan+FA, upper graph) and ferulated chitosan (down graph) produced by enzymatic grafting as explained in example 2. Column: TSKgel G 4000 PWXL (7.8 mm ID×30 cm), flow rate 0.5 mL/min, mobile phase: Acetic acid 0.3 M/Sodium acetate 0.2 M, detection UV detector.

In the chromatogram of the mixture of chitosan and ferulic acid (Chitosan+FA), two peaks are detected: the first peak (5.5 mL-9 mL) corresponds to unmodified high molecular weights chitosan, while ferulic acid separates from the initial mixture during the analysis and elutes later from the column (second peak, 11 mL-14 mL). Chitosan absorbs little in UV (320 nm)—so the first peak is smaller, while ferulic acid produces a more intense signal due to its strong absorption in UV at 320 nm.

The profile of ferulated chitosan obtained by enzymatic grafting is completely different: Only a large peak corresponding to modified high molecular weight chitosan with strong absorption in the UV is observed. The intensification in absorption at 320 nm of the modified chitosan is due to the presence of ferulic acid residues attached to the high molecular weight polysaccharide chains. The absence of free residues of ferulic acid in the ferulated chitosan is also explained by the subsequent washing steps with 50% and 90% methanol solutions to remove unreacted ferulic acid during the preparation (Example 3 step 6).

### Example 9

### Ferulated Chitosan Enhances Flowering in New Guinea Impatient Plants

Different treatments were applied by foliar spraying on one-month old new guinea impatient plants cultivar Sony pink once a week for 8 weeks. The effect of foliage of application on the inflorescence was evaluated at the end of the flowering step (22 weeks after sowing) and the results are shown in Table 12.

TABLE 12
Effect of different foliar spraying treatment on impatient plant flowering

| | Total number of | Average diameter |
|---|---|---|
| Foliar spraying treatment | flowers per plant | of the flowers (cm) |
| Untreated | 72.0 | 6.42 |
| Chitosan | 75.0 | 6.48 |
| Ferulic acid | 60.0 | 6.40 |
| Diferulic acid | 74.2 | 6.52 |
| Chitosan + Ferulic acid | 73.2 | 6.46 |
| Chitosan + Diferulic acid | 78.8 | 6.68 |
| Ferulated chitosan | 114.0 | 6.95 |

The results of this experiment show that ferulated chitosan treated plants showed a larger percentage of flowering. Additionally, larger flowers were observed in ferulated chitosan treated plants in comparison to untreated plants. Neither the chitosan, ferulic acid or oligomers of ferulic acid alone, nor the simple combination of chitosan with ferulic acid or oligomers of ferulic acids does not show the same effectiveness as ferulated chitosan in inducing impatient plants flowering.

1. Use of a composition for regulation and/or stimulation of plant growth in a targeted plant, said composition comprising ferulated chitosan, wherein said composition is applied to said targeted plant and/or to soil in contact with said targeted plant.

2. The use according to claim 1, wherein said regulation and/or stimulation of plant growth comprises increasing harvest yield of said targeted plant.

3. The use according to claim 1, wherein said regulation and/or stimulation of plant growth comprises increasing flowering of said targeted plant.

4. The use according to claim 1, wherein said regulation and/or stimulation of plant growth comprises shortening the time to harvest.

5. The use according to any claim 1, wherein said regulation and/or stimulation of plant growth comprises increasing the amount of fruit produced by the targeted plant.

6. The use according to claim 1, characterized in that, said ferulated chitosan has a concentration of between 1 to 100.000 ppm based on a total weight of said composition.

7. The use according to claim 1, characterized in that, said ferulated chitosan comprises an oligomeric and/or polymeric compound following formula (I) 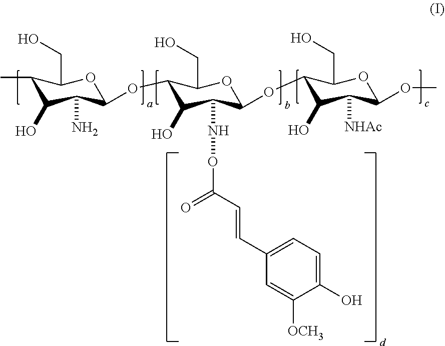
which compound comprises a D-glucosamine moiety (a), a ferulated D-glucosamine moiety (b), an acetylated D-glucosamine moiety (c), wherein said moieties are randomly distributed in said compound following a ratio a:b:c, wherein:
a+b+c>15;
b/(a+b+c)<0.10; and
c/(a+b+c)<0.30;
and wherein d=1, 2 or 3.

8. The use according to claim 1, characterized in that, said composition comprises a water-insoluble solvent and water, wherein said composition is an oil-in-water emulsion having an oil to water ratio of between 1:20 to 20:20.

9. The use according to claim 8, characterized in that, said water-insoluble solvent has a concentration of between 5.00 and 50.00 wt. % based on the a total weight of said composition.

10. The use according to claim 8, characterized in that, the composition comprises a rheological modifier, wherein said rheological modifier has a concentration of between 0.10 and 30.00 wt. % based on a total weight of said composition.

11. The use according to claim 8, characterized in that, the composition comprises a hydrophilic and/or a lipophilic surfactant, wherein said hydrophilic and/or lipophilic surfactant have a concentration of between 0.01 and 10.00 wt. % based on a total weight of said composition.

12. The use according to claim 8, characterized in that, the water-insoluble solvent is a vegetable oil or vegetable oil ester, chosen from linseed oil, rapeseed oil, soybean oil, palm oil, coconut oil, canola oil, sunflower oil, their esters, or combinations thereof.

13. The use according to claim 1, characterized in that, the composition has a pH of between 4.0 and 7.0.

14. The use according to claim 1, wherein said applying the composition to the targeted plant comprises foliar application through spraying of the composition on leaves of the targeted plant.

15. The use according to claim 1, wherein said applying the composition to the targeted plant comprises soil application through spraying and/or drenching of the composition on the soil in contact with said targeted plant.

16. A method for the production of ferulated chitosan comprising the steps of:
dispersing chitosan in a solution with a pH between 5.0 and 9.0 and adding ferulic acid and an enzyme of the family of multi-copper oxidases, obtaining a mixture;
allowing the mixture to enzymatically react; and
recovering a precipitate from the reacted mixture.

17. Ferulated chitosan obtainable according to claim 16.

18. The use according to claim 13, characterized in that, the pH is between 5.0 and 6.5.
